(19) United States
(12) Patent Application Publication
(10) Pub. No.: US 2023/0169304 A1
(43) Pub. Date: Jun. 1, 2023

(54) METHOD OF EXTRACTING INFORMATION SET BASED ON PARALLEL DECODING AND COMPUTING SYSTEM FOR PERFORMING THE SAME

(71) Applicant: DEEP HIGH INC., Daegu (KR)

(72) Inventors: Young Kwang HA, Hwaseong-si (KR); Choong Sup Shim, Seoul (KR); Jong Yeol Lee, Gwangju-si (KR)

(21) Appl. No.: 17/991,782

(22) Filed: Nov. 21, 2022

(30) Foreign Application Priority Data
Nov. 26, 2021 (KR) 10-2021-0165642

(51) Int. Cl. G06N 3/02; G06K 9/62

(52) U.S. Cl. CPC G06N 3/02; G06K 9/6256

(57) ABSTRACT

An information set extraction method based on parallel decoding for extracting m information sets (where m is an arbitrary integer greater than or equal to 1) including n attributes (where n is an arbitrary integer greater than or equal to 1) from a document, the information set extraction method including: receiving, by a system comprising a neural network model of a sequence-to-sequence (seq2seq) structure, a document; and determining m information sets through a plurality of times of decoding. The determining of m information sets through a plurality of times of decoding includes determining first column information having m first attributes through decoding; and determining i-th column information having m i-th attributes based on at least one of the first to (i−1)-th column information through decoding (where i is an arbitrary integer such that 2<=i<=n).

### CROSS-REFERENCE TO RELATED APPLICATION

This application claims priority from and the benefit of Korean Patent Application No. 10-2021-0165642, filed on Nov. 26, 2021, which is hereby incorporated herein by reference for all purposes as if fully set forth herein.

### BACKGROUND

### Field

Exemplary embodiments of the present invention relate to a method and system for extracting meaningful information from text data. More particularly, the exemplary embodiments of the present invention relate to a method and system capable of effectively extracting text information, in other words, information corresponding to each of a plurality of predefined properties from a document based on deep learning.

### Discussion of the Background

Research is actively being conducted regarding deep learning models for natural language processing.

In particular, text has a lot of information in the form of various unstructured data, and is highly likely to be utilized in various fields by properly analyzing such information to understand people's thoughts, reactions, psychology, or current situation.

Such text analysis may be utilized in various fields such as commerce, such as product or policy planning/development, management of consumer reactions, investment direction, etc., finance, research, and defense.

In general, various deep learning models are used to extract meaningful information to be extracted from unstructured data that does not have a specific format.

Representatively, there are methods utilizing Named Entity Recognition (NER), a classification model of words or sentences, and Machine Reading Comprehension (MRC).

FIG. 1 exemplarily illustrates the concept of extracting information from a document that is unstructured data.

As shown in FIG. 1, the document may include a plurality of pieces of information that a user wants to know. In addition, the user may want to extract a plurality of types of information to be extracted (hereinafter referred to as attributes) (e.g., attribute a, attribute b, attribute c). An extraction result of each attribute may be a1, b1, c1, as shown in FIG. 1.

In this specification, a set of these attributes will be defined as an information set.

In this case, a conventional method has a disadvantage in that several individual models are needed to classify/extract each attribute or obtain it through a question.

For example, according to Korean Patent Application No. 10-2021-0143120, an individual classification model or MRC model for extracting each attribute should be built to extract each attribute (detailed profile) included in a user profile, for example, meaningful information, such as the user's gender, marital status, existence of children, purchase status, or the like, in other words, in order to extract a plurality of attributes from unstructured data.

In this case, building each model not only requires much time and money, but also takes a relatively long time to extract information, and various disadvantages may exist.

The above information disclosed in this Background section is only for understanding of the background of the inventive concepts, and, therefore, it may contain information that does not constitute prior art.

### SUMMARY

Exemplary embodiments of the present invention provide a very effective method and a system therefor for extracting at least one information set having a plurality of attributes from unstructured data through a neural network having a sequence-to-sequence (Seq2Seq) structure, in other words, an encoder and decoder structure.

In particular, exemplary embodiments of the present invention provide a method and a system capable of parallel decoding that can relatively compensate for a large number of decoding times, which is a disadvantage of the Seq2Seq structure.

Additional features of the invention will be set forth in the description which follows, and in part will be apparent from the description, or may be learned by practice of the invention.

An exemplary embodiment of the present invention provides an information set extraction method based on parallel decoding for extracting m information sets (where m is an arbitrary integer greater than or equal to 1) including n attributes (where n is an arbitrary integer greater than or equal to 1) from a document includes receiving, by a system comprising a neural network model of a sequence-to-sequence (seq2seq) structure, a document, and determining, by the system, m information sets through a plurality of times of decoding, wherein the determining of, by the system, m information sets through a plurality of times of decoding includes determining, by the system, first column information having m first attributes through decoding, and determining, by the system, i-th column information having m i-th attributes based on at least one of the first to (i−1)-th column information through decoding (where i is an arbitrary integer such that 2<=i<=n).

According to the present invention, since information having different properties may be extracted together through unstructured data, there is an effect that it is not necessary to build a model for extracting information for each individual property.

In addition, since parallel decoding may be used by improving the disadvantages of the Seq2Seq structure, there is an effect of relatively reducing the number of decoding.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 exemplarily illustrates the concept of extracting information from a document that is unstructured data.

FIG. 2 is a diagram for explaining a logical configuration of an information set extraction system based on parallel decoding according to an embodiment of the present invention.

FIG. 3 is a diagram for explaining a physical configuration of an information set extraction system based on parallel decoding according to an embodiment of the present invention.

FIG. 4 is a diagram for explaining a concept of extracting a plurality of information sets through a neural network having a sequence-to-sequence structure according to an embodiment of the present invention.

FIG. 5 and FIG. 6 are diagrams for explaining a method of extracting an information set according to an embodiment of the present invention.

FIG. 7 and FIG. 8 are diagrams for explaining a method of extracting an information set according to another embodiment of the present invention

FIG. 9 is a diagram for explaining a decoding mask according to an embodiment of the present invention.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

As is customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Since the present invention may apply various modifications and may include various example embodiments, specific exemplary embodiments are illustrated in the drawings and described in detail in the detailed description. However, the exemplary embodiments are not construed as limiting the present invention to specific embodiments, and should be understood to include all changes, equivalents and replacements included in the idea and technical scope of the present invention.

Although terms of “first,” “second,” and the like are used to explain various components, the components are not limited to such terms. The terms “first”, “second”, and the like do not indicate a particular order and are used only to distinguish one component from another component.

Terms used in the present application are used only to illustrate specific exemplary embodiments, and are not intended to limit the present invention. As used herein, the singular forms are intended to include the plural forms as well, unless the context clearly indicates otherwise.

It should be understood that the terms “comprise” and/or “have,” when used in this specification, specify the presence of stated features, integers, steps, operations, elements, components or a combination thereof, but do not preclude the presence or addition of one or more other features, integers, steps, operations, elements, components, and/or groups thereof.

In addition, in the present specification, when one component ‘transmits’ data to another component, it indicates that the component may directly transmit the data to the other component directly or through at least one other component. In contrast, when one component ‘directly transmits’ data to another component, it indicates that the data is transmitted from the component to the other component without passing through still another component.

Hereinafter, exemplary embodiments will be described in detail with reference to the accompanying drawings. Like reference numerals in each drawing indicate like components.

FIG. 2 is a diagram for explaining a logical configuration of an information set extraction system based on parallel decoding according to an embodiment of the present invention.

Referring to FIG. 2, a method of extracting an information set based on parallel decoding according to the technical idea of the present invention may be performed by an information set extraction system based on parallel decoding (hereinafter, a “system”) 100.

The system 100 logically includes a neural network 120 of a sequence-to-sequence structure for implementing the technical idea of the present invention. The system 100 may include a training system 110 for training the neural network 120 and a determination providing system 130 for extracting determination of the neural network 120 through the trained neural network 120, in other words, an information set.

Depending on implementation examples, the training system 110 and the determination providing system 130 may not be separated, or may be integrated.

The training system 110 and/or the determination providing system 130 may be a computing system that is a data processing device having computational capability for implementing the technical idea of the present invention, and generally include a computing device such as a personal computer or a portable terminal as well as a server that is a data processing device accessible by a client through a network.

The training system 110 and/or the determination providing system 130 may be implemented as any one physical device, but those skilled in the art to which the present invention pertains will easily appreciate that a plurality of physical devices may be organically combined to implement the training system 110 and/or the determination providing system 130 according to the technical idea of the present invention, if necessary.

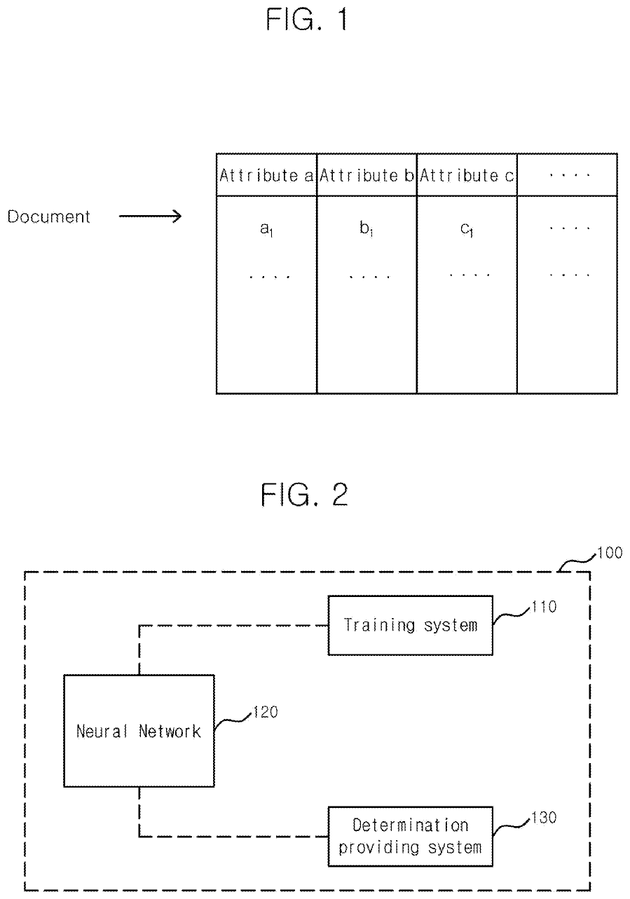

As shown in FIG. 1, the training system 110 and/or the determination providing system 130 may be implemented in the form of a subsystem of a predetermined parent system. The parent system may be a server. The server means a data processing device having computational capability for implementing the technical idea of the present invention, and those skilled in the art will easily appreciate that, in general, any device capable of performing a specific service, such as a personal computer or a portable terminal, as well as a data processing device accessible by a client through a network may be defined as a server. Then, the training system 110 and/or the determination providing system 130 may refer to a system implemented by organically combining hardware of the server and software for implementing the technical idea of the present invention.

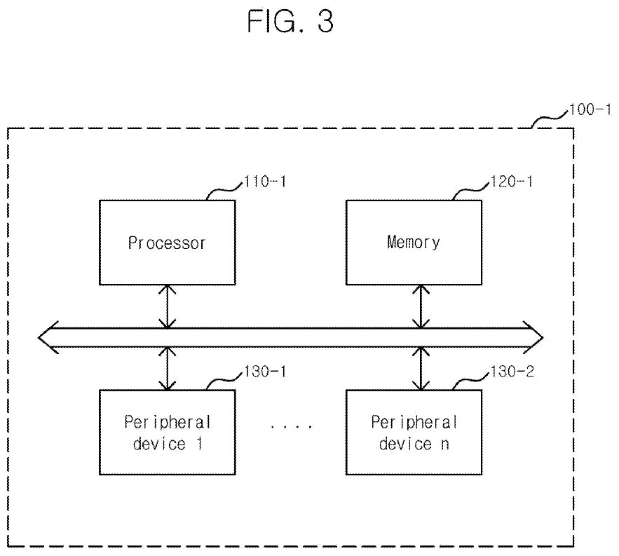

FIG. 3 is a diagram for explaining a physical configuration of an information set extraction system based on parallel decoding according to an embodiment of the present invention.

The system 100 may have the physical configuration as shown in FIG. 3. A system 100-1 may include a memory (storage device) 120-1 in which a program for implementing the technical idea of the present invention is stored, and a processor 110-1 for controlling or executing the program stored in the memory 120-1 and a neural network.

Those skilled in the art will easily appreciate that the processor 110-1 may be referred to as various names such as a CPU, a mobile processor, etc., depending on implementation examples of the system 100-1. In addition, as described in FIG. 2, the system 100-1 may be implemented by organically combining a plurality of physical devices. In this case, those skilled in the art can easily appreciate that the system 100-1 may be implemented such that each of the plurality of physical devices is provided with at least one processor 110-1.

The memory 120-1 stores the program and the neural network 120, and may be implemented as any type of storage device that the processor can access to train the neural network 120 by driving the program or to obtain an output result of the neural network 120. Further, depending on examples of hardware implementation, the memory 120-1 may be implemented as a plurality of storage devices instead of any one storage device. Further, the memory 120-1 may include a temporary memory as well as a main memory. In addition, the memory 120-1 may be implemented as a volatile memory or a non-volatile memory, and may be defined to include all types of information storage means implemented so that the program can be stored and driven by the processor.

In addition, according to embodiments of the system 100, various peripheral devices (peripheral device 1 to peripheral device N) 130-1 and 130-2 may be further provided. For example, those skilled in the art will easily appreciate that a keyboard, monitor, graphic card, communication device, etc. may be further included in the system 100 as peripheral devices.

Hereinafter, when the system 100 performs a certain function in the present specification, those skilled in the art will easily appreciate that the processor 110-1 drives a program stored in the memory 120-1 to control the neural network 120 to perform the function.

In addition, in the present specification, the neural network 120 is a neural network artificially built based on an operation principle of human neurons, including a multi-layer perceptron model, and may indicate a set of information expressing a series of design items defining the artificial neural network.

The neural network 120 may be a model having a well-known sequence-to-sequence structure. The sequence-to-sequence structure is suitable for a model that connects and uses an encoder and a decoder and that is trained to output text when text is input using time-series information.

As a model of the sequence-to-sequence structure, a seq2seq model using a Recurrent Neural Network (RNN), a Transformer model that improves shortcomings of the seq2seq model and uses attention, or the like, is widely known.

Since the seq2seq model and the transformer model corresponding to the sequence-to-sequence structure are widely known, detailed descriptions will be omitted in this specification. Although example embodiments are described using mainly a decoding method used in the transformer model in this specification, those skilled in the art will easily appreciate that the scope of the present invention is not be limited thereto.

Typically, the model of the sequence-to-sequence structure is widely used to generate continuous text such as chatbots and translation engines.

However, according to the technical idea of the present invention, by extracting at least one information set using a model of the sequence-to-sequence structure, it is possible to extract information very effectively compared to the conventional method.

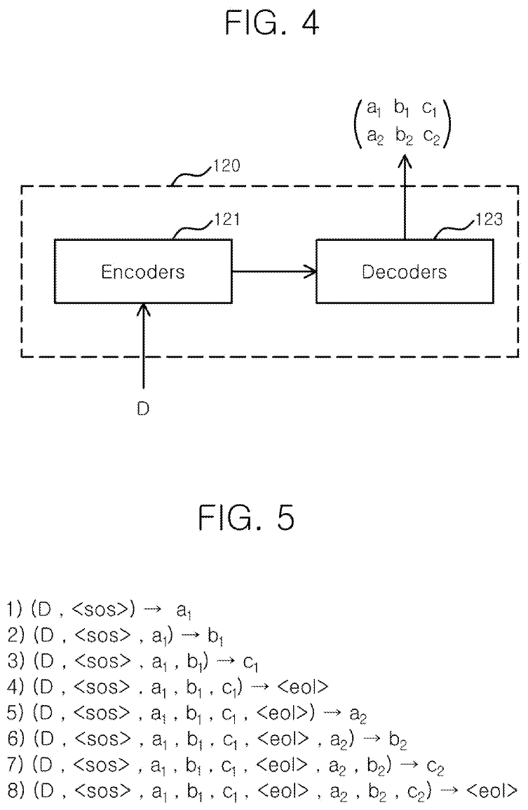

FIG. 4 is a diagram for explaining a concept of extracting a plurality of information sets through a neural network having a sequence-to-sequence structure according to an embodiment of the present invention.

Referring to FIG. 4, the neural network 120 trained according to the technical idea of the present invention may extract m information sets (where m is any integer greater than or equal to 1) including n attributes (where n is an arbitrary integer greater than or equal to 1) when a document D, which is unstructured text data, is input.

Hereinafter, example embodiments in which n is 3 and m is 2 are described in the present specification, but the scope of the present invention is not limited thereto.

The neural network 120 such as the transformer, which is an example of the neural network model having the sequence-to-sequence structure, may include encoders 121 and decoders 123 as shown.

When the document D, which is unstructured data, is input, the neural network 120 may output a plurality of information sets having different attributes (e.g., a, b, c) as shown in FIG. 4.

If such a plurality of information sets are referred to as table information in this specification, FIG. 4 illustrates a case in which two information sets having three attributes are output as an example. Therefore, the case may be defined as a case in which table information of 2 rows and 3 columns is extracted.

The decoders 123 included in the neural network 120 may extract the table information through a plurality of times of decoding.

In this case, the decoders 123 may be implemented to sequentially decode each element (e.g., a1, b1, c1, a2, b2, c2) included in the table information one by one.

The neural network model 120 is can be determined output from each of the vectors output from the decoder 123, through a greedy search or a beam search, by selecting a component with a probability value above a predefined threshold.

In order to train the neural network 120 according to the technical idea of the present invention having the function, the neural network 120 may be trained through training data as shown in FIG. 5.

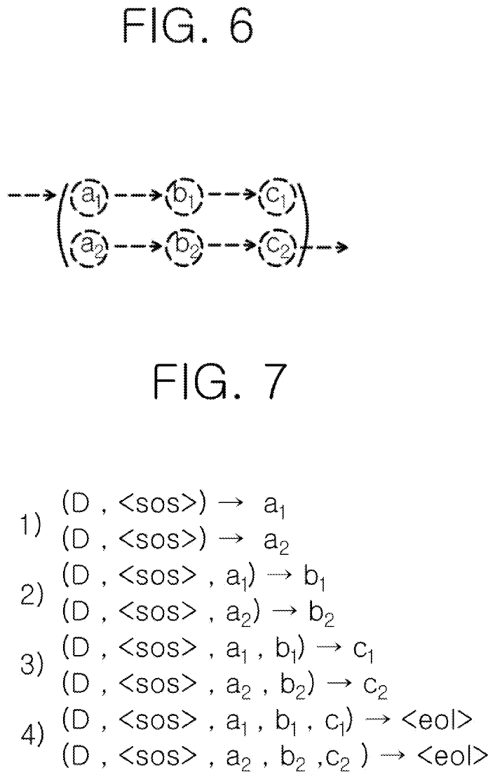

Then, the neural network 120 may sequentially output elements to be included in the table information one by one as a decoding result in the order shown in FIG. 6, and finally the table information may be determined.

For example, if the decoders 123 first receive a document D (i.e., information encoded by the encoders 121) as an input (with an additional start of sentence (SOS) if necessary), then it is trained to output a1.

The decoders 123 is trained to output b1 when it receives the document (and the starting instance) and previously decoded information a1 as input. In addition, when the document (and the starting instance) and previously decoded information a1 and b1 are received as inputs, c1 is trained to be output. In addition, if the document (and the starting instance) and previously decoded information a1, b1, and c1 are received as inputs, it may be trained to output the next instance a2 or depending on the embodiment, for example, an end of line instance It may be trained to output.

In this way, when the document (and starting instance) and previously decoded a1, b1, c1, (line break instance if necessary) are received as input, the decoder 123 is trained to output a2, when the decoder 123 receives the document (and starting instance) and previously decoded a1, b1, c1, (line break instance if necessary), and a2 as input, the decoder 123 is trained to output b2, and when the document (and starting instance) and previously decoded a1, b1, c1, (if necessary line break instance), a2, and b2 is received the decoder is trained to output c2. Finally, the document (and starting instance) and previously decoded a1, b1, c1 (line break instance if necessary), and the decoder 123 is trained to output <eol>.

Then, the neural network 120 can sequentially output the elements to be included in the table information one by one as a decoding result in the order shown in FIG. 6, and finally the table information can be determined.

As such, according to the present invention, when certain elements are output from a specific document, each element can be trained to be output through a sequence-to-sequence model, and in this case, a classification model and an MRC engine for each component are not separately built.

However, this method has a disadvantage in that a number of decoding processes must be performed (e.g., at least the number of elements to be output), and as decoding progresses, the amount of input data input to the decoder increases. In order to solve these problems, according to the technical concept of the present invention, the decoders 123 of the sequence-to-sequence model may perform parallel decoding.

In another embodiment, the decoders 123 may perform decoding according to the same attribute, in other words, for each column among the elements included in the table information. In this case, the first column information (e.g., a1 a2) may be determined through decoding.

In order to train the neural network 120 according to the technical idea of the present invention having the function, the neural network 120 may be trained through training data as shown in FIG. 7.

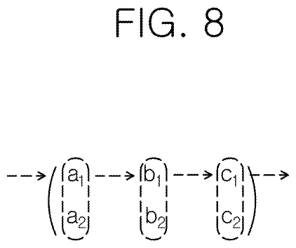

Then, the neural network 120 may output elements to be included in the table information in the order shown in FIG. 8 as a decoding result in units of columns, and finally the table information may be determined.

Unlike the conventional sequence-to-sequence model that sequentially decodes one by one, the method shown in FIG. 7 or FIG. 8 consequently decodes a plurality of pieces of information (elements included in the same column) substantially at once and, accordingly is referred to as parallel decoding in the present specification.

Determining column information may indicate that output vectors of the decoders 123 capable of determining each element included in the column information are determined as is well known.

Those skilled in the art will easily appreciate that an object defined in this specification (e.g., column information, element, document, etc.) may be construed as a meaning including a vector corresponding thereto.

As shown in FIG. 8. The decoders may output first column information (e.g., a1 a2) upon receiving the document D and a start instance. Then, when the first column information (e.g., a1 a2) is determined, the decoders 123 may receive the document D and the first column information as inputs, and output second column information (b1 b2) as a decoding result.

Then, when the second column information (e.g., a1 a2) is determined, the decoders 123 receive the document D, the first column information, and the second column information as inputs, and output third column information (b1 b2) as a decoding result.

And, if necessary, the decoders 123 can be trained to receive the document D, first column information, second column information, and third column information as inputs, and output line break instances as decoding results.

Then, as shown in FIG. 8, the first column information (a1 a2) is output through one decoding, the second column information (b1, b2) is output through the next decoding, and the third column information (c1, c2) is output through the next decoding. Decoding may be performed in such a way.

When the decoders 123 are trained in this way and the trained model is used, one column information can be output with one decoding, and as a result, there is an effect that can overcome the disadvantage of the number of decoding and due to this long computation time due to the exponential increase of continuous decoding, which is a disadvantage of the sequence-to-sequence model. In the examples of FIGS. 5 and 7 described above, it can be seen that the number of times of decoding is much reduced when only 2 by 3 table is needed. If table size is larger, then it can be seen that the effect can be remarkably large.

For example, regarding the embodiments of FIGS. 5 and 7, if a document (D) exists and this document (D) is input, neural network in which <SOS>, <a1>, <b1>, <c1>, <EOL>, <a2>, <b2>, and <c2> are output as respective elements may be trained.

In this case, in the embodiment of FIG. 5, when one element is sequentially input to the decoder, the next element becomes the output of the decoder.

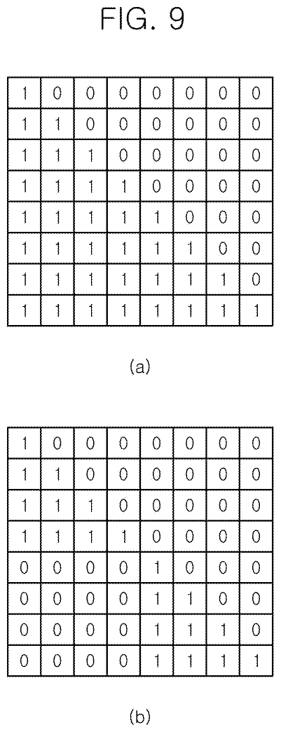

Therefore, as shown in FIG. 9A, for example, when the first row (1, 0, 0, 0, 0, 0, 0, 0) of the mask M is applied, it means that <SOS>, the first component of <SOS>, <a1>, <b1>, <c1>, <EOL>, <a2>, <b2>, and <c2>, is selected as the input of the decoder (of course, encoded D can always be included as input). In next decoding when the second row (1, 1, 0, 0, 0, 0, 0, 0) of the mask M is applied, it means that <SOS> and <a1>, the first and second element of <SOS>, <a1>, <b1>, <c1>, <EOL>, <a2>, <b2>, and <c2>, is selected as the input of the decoder.

In this way, decoding may be performed in such a way that inputs of decoders are sequentially selected, and outputs of the resulting decoders become inputs of the next decoding.

Meanwhile, in the embodiment of FIG. 7, parallel decoding may be performed as described above.

In this case, when the first row (1, 0, 0, 0, 0, 0, 0, 0) and the fourth row (0, 0, 0, 0, 1, 0, 0, 0) of the mask M are applied, <SOS> and <EOL>, which are the first and fourth components of <SOS>, <a1>, <b1>, <c1>, <EOL>, <a2>, <b2>, <c2>, are selected as inputs to the decoder. (If necessary, it can be treated the same as a special elements). In next decoding, when the second row (1, 1, 0, 0, 0, 0, 0, 0) and the fourth row (0, 0, 0, 0, 1, 1, 0, 0) of the mask M are applied, <SOS>, <a1> and <EOL>, <a2> among <SOS>, <a1>, <b1>, <c1>, <EOL>, <a2>, <b2>, <c2>, are selected as inputs to the decoder.

By defining a decoder mask that selects input elements of the decoder in this way, a decoder performing parallel decoding can be implemented.

In order to implement the neural network 120, a plurality of training documents and labeling data of each training document, i.e., labeling table information, may be required.

Further, in order to train the neural network 120 as described in FIGS. 7 and 8 from this labeling table information, a decoding mask to be applied to the labeling table information may be required, and this may be as shown in FIG. 9B. Of course, in order to train the neural network 120 as described with reference to FIGS. 5 and 6, a decoding mask to be applied to the labeling table information may be required, and this may be as shown in FIG. 9A.

A mask M of FIG. 9B may satisfy the following conditions.

M={aij}

aij=1, (if (n+1)*k<i<=(n+1)*(k+1), and

(n+1)*k<j<=(n+1)*(k+1), where k is the quotient of max(i,j) divided by (n+1))

=0 else

According to implementation examples, the system 100 may include a processor and a memory for storing a program executed by the processor. The processor may include a single-core CPU or a multi-core CPU. The memory may include a high-speed, random-access memory, and may include a non-volatile memory such as one or more magnetic disk storage devices, flash memory devices, or other non-volatile solid-state memory devices. Access to the memory by the processor and other components may be controlled by a memory controller.

In addition, the method according to the example embodiment of the present invention may be implemented in the form of computer-readable program instructions and stored in a computer-readable recording medium, and a control program and a target program according to the example embodiment of the present invention may also be stored in a computer-readable recording medium. The computer-readable recording medium includes all types of recording devices in which data readable by a computer system is stored.

The program instructions recorded on the recording medium may be specially designed and configured for the present invention, or may be known and available to those skilled in the software field.

Examples of the computer-readable recording medium include magnetic media such as hard disks, floppy disks, and magnetic tapes, optical media such as CD-ROMs and DVDs, magneto-optical media such as floptical disks, and hardware devices specially configured to store and execute program instructions, such as ROMs, RAMs, flash memory, and the like. In addition, the computer-readable recording medium is distributed in a computer system connected through a network, so that the computer-readable code may be stored and executed in a distributed manner.

Examples of the program instruction include not only machine code such as those generated by a compiler, but also high-level language code that can be executed by a device for electronically processing information using an interpreter or the like, for example, a computer.

The hardware devices described above may be configured to operate as one or more software modules to perform operations of the present invention, and vice versa.

The foregoing description of the present invention is for illustration, and those skilled in the art to which the present invention pertains will understand that the present invention may be easily modified into other specific forms without changing the technical spirit or essential features of the present invention. Therefore, it should be understood that the example embodiments described above are illustrative in all respects and not restrictive. For example, each component described as a single component may be implemented in a distributed manner, and likewise components described as distributed may be implemented in a combined form.

The scope of the present invention is indicated by the appended claims rather than the above detailed description, and all changes or modifications derived from the meaning and scope of the claims and their equivalents should be construed as being included in the scope of the present invention.

What is claimed is:

1. An information set extraction method based on parallel decoding for extracting m information sets (where m is an arbitrary integer greater than or equal to 1) including n attributes (where n is an arbitrary integer greater than or equal to 1) from a document, the information set extraction method comprising:
receiving, by a system comprising a neural network model of a sequence-to-sequence (seq2seq) structure, a document; and
determining, by the system, m information sets through a plurality of times of decoding,
wherein the determining of, by the system, m information sets through a plurality of times of decoding comprises:
determining, by the system, first column information having m first attributes through decoding; and
determining, by the system, i-th column information having m i-th attributes based on at least one of the first to (i−1)-th column information through decoding (where i is an arbitrary integer such that 2<=i<=n).

2. The information set extraction method of claim 1, wherein the determining of, by the system, m information sets through a plurality of times of decoding comprises selecting, by the system, an element having a value greater than or equal to a predefined threshold from each of output vectors output from a decoder through a greedy search or a beam search to determine it as an element of the first column information or the i-th column information.

3. The information set extraction method of claim 1, further comprising:
training, by the system, the neural network using a plurality of training documents and a plurality of pieces of training data including labeling data in which at least one information set including n attributes is labeled for each of the plurality of training documents (where n is an arbitrary integer greater than or equal to 1).

4. The information set extraction method of claim 3, wherein the training of the neural network comprises:
when p information sets are labeled in the labeling data of specific training data (where p is any integer greater than or equal to 1),
training, by the system, the neural network so that, when the neural network receives the document and a start instance as inputs for each of p labeled elements included in the first column information, each of the p labeled elements included in the first column information is output; and
training, by the system, the neural network so that, when the neural network receives the document and the first to the (k−1)-th labeled elements as inputs for each of the p labeled elements included in the k-th column information, each of the p labeled elements included in the k-th column information is output (where k is an arbitrary integer such that 2<=i<=n).

5. The information set extraction method of claim 4, wherein the training of the neural network comprises applying, by the system, a predetermined decoder mask to each labeling data included in the plurality of pieces of training data, and
the decoder mask M satisfies the following conditions:
M={aij}
aij=1, (if (n+1)*k<i<=(n+1)*(k+1), and
(n+1)*k<j<=(n+1)*(k+1), where k is the quotient of max(i,j) divided by (n+1))=
0 else

6. A computer program recorded in a non-transitory recording medium and installed in a data processing device for performing the method according to any one of claim 1.

7. An information set extraction system based on parallel decoding, comprising:
a processor; and
a memory configured to store a program executed by the processor and a neural network model of a sequence-to-sequence (seq2seq) structure,
wherein, in order to extract m information sets (where m is an arbitrary integer greater than or equal to 1) including n attributes from a document (where n is an arbitrary integer greater than or equal to 1), the processor executes the program to receive the document and determine the m information sets by a plurality of times of decoding through the neural network model, and
the processor executes the program to determine first column information having m first attributes through decoding and determine i-th column information having m i-th attributes based on at least one of the first to (i−1)-th column information through decoding (where i is an arbitrary integer such that 2<=i<=n).

8. The information set extraction system of claim 7, wherein the processor executes the program to select an element having a value greater than or equal to a predefined threshold from each of output vectors output from a neural network model decoder through a greedy search or a beam search to determine it as an element of the first column information or the i-th column information.

9. The information set extraction system of claim 7, wherein the processor executes the program to train the neural network using a plurality of training documents and a plurality of pieces of training data including labeling data in which at least one information set including n attributes is labeled for each of the plurality of training documents (where n is an arbitrary integer greater than or equal to 1).

10. The information set extraction system of claim 9, wherein the processor executes the program to:
when p information sets are labeled in the labeling data of specific training data (where p is any integer greater than or equal to 1),
train the neural network so that, when the neural network receives the document and a start instance as inputs for each of p labeled elements included in the first column information, each of the p labeled elements included in the first column information is output; and
train the neural network so that, when the neural network receives the document and the first to the (k−1)-th labeled elements as inputs for each of the p labeled elements included in the k-th column information, each of the p labeled elements included in the k-th column information is output (where k is an arbitrary integer such that 2<=i<=n).
